(19) United States
(12) Patent Application Publication
(10) Pub. No.: US 2011/0102404 A1
(43) Pub. Date: May 5, 2011

(54) Low Power Driving Method for a Display Panel and Driving Circuit Therefor

(75) Inventor: Chun-Lin Hou, Hsinchu City (TW)

(73) Assignee: RAYDIUM SEMICONDUCTOR CORPORATION, Hsinchu (TW)

(21) Appl. No.: 12/868,117

(22) Filed: Aug. 25, 2010

(30) Foreign Application Priority Data
Aug. 26, 2009 (TW) 98128641

(51) Int. Cl. G09G 5/00

(52) U.S. Cl. 345/211

(57) ABSTRACT

A low power driving method for a display panel and a driving circuit therefor. When the voltage of a corresponding common electrode of a pixel in a pixel array is changed from one of the first voltage and the second voltage to the other thereof according to a polarity signal, the voltage of the corresponding pixel electrode of the pixel is driven. In an embodiment, a data code for the pixel and the polarity signal are utilized to predict a trend of the corresponding target voltage of the data code, and the voltage of the pixel electrode or the data line is changed to a voltage close to the target voltage of the pixel according to the prediction result. Thus, the swing range of the voltage of the data line can be efficiently reduced, and power saving and reduction in transition time can also be achieved.

This application claims the benefit of Taiwan application Serial No. 98128641, filed Aug. 26, 2009, the subject matter of which is incorporated herein by reference.

### BACKGROUND OF THE INVENTION

1. Field of the Invention

The invention relates in general to a driving method for display panel and a driving circuit therefor, and more particularly to a low power driving method for a display panel and a driving circuit therefor.

2. Description of the Related Art

The generally known method for driving a panel achieves power saving and reduction in transition time by way of pre-charging. According to the method disclosed in U.S. Pat. No. 7,362,293, during consecutive scan periods, the common voltage Vcom of a common electrode is continually changed by way of line inversion driving method, and the swing range of the source line and the common electrode are narrowed by way of pre-charging.

However, the above conventional driving method may even increase power consumption under certain circumstances. For example, when the common voltage Vcom is changed from a low common voltage VcomL to a high common voltage VcomH and the target voltage of the source line has to maintain at the same level or change to a lower level (the voltages for the two cases are both denoted by VcomL+Vb), according to the above method, the voltage of the source line and the common voltage will be pre-charged and pulled up to a reference voltage VCI, wherein VCI>VcomL+Vb. After pre-charging is completed, the voltage of the source line has to reduce to a target voltage, that is, VcomL+Vb. For example, when the common voltage Vcom is changed from the high common voltage VcomH to the low common voltage VcomL while the target voltage of the source line has to maintain at the same or a higher level (the voltages for the two cases are both denoted by VcomH−Va), according to the above method, the voltages of the source line and the common voltage will be pre-charged and pulled down to a ground voltage GND, wherein VcomH−Va>VCI, and VCI>GND. After pre-charging is completed, the voltage of the source line has to be pulled down to the target voltage, that is, VcomH−Va.

As disclosed above, under many circumstances, the conventional driving method does not narrow the swing range of the source line and may even increase power consumption and the transition time instead, thus degrading its performance.

### SUMMARY OF THE INVENTION

The invention is directed to a driving method for display panel and a device therefor. According to an embodiment of the invention, the corresponding data code of the grey level to be displayed by the pixel is utilized to predict a trend of the corresponding target voltage of the data line, and according to the prediction result, the voltage of the data line is changed to a voltage close to the target voltage. Thus, the swing range of the voltage of the data line can be efficiently reduced, and power saving and reduction in transition time can also be achieved.

According to a first aspect of the present invention, a driving method for driving a pixel array of a display panel is provided. The driving method includes the following steps: When the voltage of a corresponding common electrode of a pixel in a pixel array is changing from one of a first common voltage and a second common voltage to the other thereof according to a polarity signal, the voltage of the corresponding pixel electrode of the pixel is driven. The driving step includes the following: (a) Within a first time interval, selectively changing the voltage of the pixel electrode of the pixel to one of at least two voltages such as a first voltage and a second voltage according to the value of a data code for the pixel and the polarity signal is performed, so that the voltage of the pixel electrode, after having been pre-charged, becomes closer to a corresponding target voltage of the data code. (b) Within a second time interval, enabling the pixel electrode, whose voltage has been changed, to receive the target voltage so as to generate a desired voltage difference between the common electrode and the pixel electrode of the pixel, wherein the second common voltage is larger than the second voltage, the second voltage is larger than the first voltage, and the first voltage is larger than the first common voltage.

According to a second aspect of the present invention, a driving circuit for driving a pixel array of a display panel is provided. The driving circuit includes a data driving circuit, a voltage prediction circuit, and a voltage selection circuit. The data driving circuit is for driving a plurality of data lines corresponding to the pixel array according to a plurality of data codes and at least one polarity signal. With respect to each of the data codes, the voltage prediction circuit is for generating a plurality of data line control signals corresponding to the data code and a plurality of common electrode control signals corresponding to the polarity signal, according to the data code and the polarity signal. The voltage selection circuit is for, according to common electrode control signal, changing a voltage of a common electrode from one of a first common voltage and a second common voltage to the other thereof. Within a time interval during a transition of the voltage of the common electrode, the voltage selection circuit is for enabling the voltage of each of the data lines to change to one of at least two voltage such as a first voltage and a second voltage, according to the data line control signals of the corresponding data code of the data line, so that the voltage of the data line becomes closer to a corresponding target voltage of the data code. After the time interval, the voltage selection circuit is for enabling the data line, whose voltage has been changed, to receive the target voltage from the data driving circuit, so as to generate a desired voltage difference between the data line and the common electrode for driving a pixel in the pixel array. The second common voltage is larger than the second voltage, the second voltage is larger than the first voltage, and the first voltage is larger than the first common voltage.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 shows a schematic diagram of a driving method according to a first embodiment of the invention.

FIG. 2 shows another schematic diagram of a driving method according to a second embodiment of the invention.

FIG. 3 shows a schematic diagram of a driving method according to a third embodiment of the invention, wherein the common voltage is changed from positive polarity to negative polarity.

FIG. 4 shows another schematic diagram of a driving method according to the third embodiment of the invention, wherein the common voltage is changed from negative polarity to positive polarity.

FIG. 5 shows a block diagram of a driving circuit for driving a display panel, according to a fourth embodiment of the invention.

FIG. 6 shows a circuit diagram of an implementation of a voltage selection circuit.

FIG. 7 shows a truth table of an embodiment of a voltage prediction circuit.

### DETAILED DESCRIPTION OF THE INVENTION

### First Embodiment

According to a driving method of the first embodiment of the invention, the voltage of a corresponding pixel electrode of a pixel is driven when the voltage of the corresponding common electrode of the pixel in a pixel array is changing from one of a first common voltage (Vcom1) and a second common voltage (Vcom2) to the other thereof according to a polarity signal. The driving step includes at least two sub-steps:

(a) Within a time interval, the voltage of the pixel electrode of the pixel is changed to one of a plurality of voltage levels, such as one of a first voltage (V1) and a second voltage (V2), selectively according to a data code for the pixel and the polarity signal, so that the voltage of the pixel electrode becomes closer to a corresponding target voltage of the data code. (b) After the time interval, the data line, whose voltage has been changed, is enabled to receive a target voltage so as to generate a desired voltage difference between the data line and the common electrode for driving a pixel in the pixel array.

In the above driving method, the data code and the polarity signal are utilized to predict a trend of the target voltage, so that the voltage of the pixel electrode can be appropriately changed to be close to the target voltage. Thus, the grey voltages in various cases of voltage transition can be achieved with power saving and reduction in transition time.

Various embodiments are provided below to illustrate how to change the voltage of the pixel electrode appropriately to be close to the target voltage.

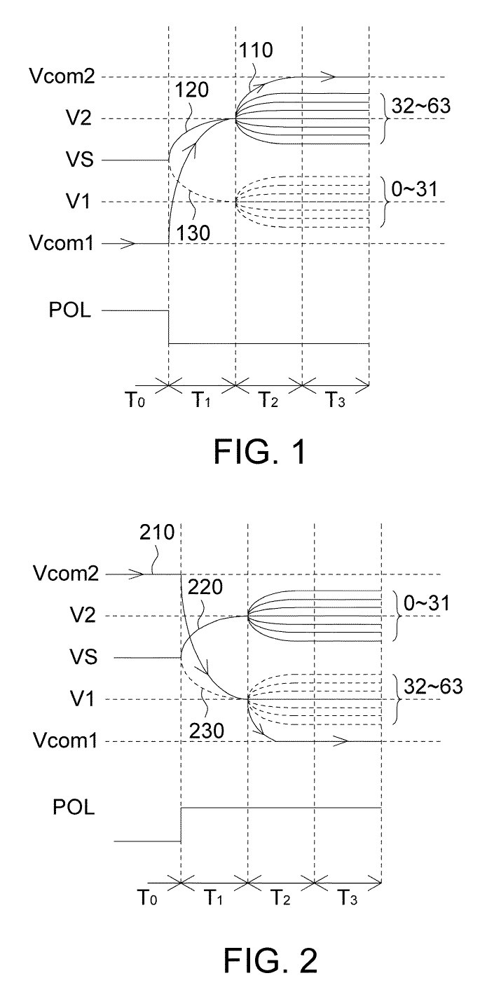

In order to achieve polarity inversion, the voltage of a common electrode is changed along with the polarity inversion. In the following examples as indicated in FIGS. 1-4, the second common voltage Vcom2 is larger than the second voltage V2, the second voltage V2 is larger than the first voltage V1, and the first voltage V1 is larger than the first common voltage Vcom1.

For the sake of illustration, the grey value and grey voltage is based on the normally white mode, which is commonly adopted in the liquid crystal display panel. One of skilled in the art can thus develop embodiments of the invention for a liquid crystal display panel which adopts the normally black mode.

### Second Embodiment

The sub-step (a) of the first embodiment makes the voltage of the pixel electrode closer to the corresponding target voltage of the data code. Based on the first embodiment, the sub-step (a) of the second embodiment appropriately changes the voltage of the pixel electrode to be closer to the corresponding target voltage of the data code through pre-charging method and the determination result in the prediction of the trend of the target voltage.

FIGS. 1 and 2 respectively show a schematic diagram of a driving method according to the second embodiment of the invention. In FIG. 1, when the polarity signal POL indicates that the common voltage is changed from positive polarity to negative polarity, as indicated by an upward curve 110 with an arrow, the common voltage is changing from a first common voltage Vcom1 to a second common voltage Vcom2, the voltage of the pixel electrode VS of a pixel is driven. In FIG. 2, when the polarity signal POL indicates that the common voltage is changed from negative polarity to positive polarity (as indicated a downward curve 210 with an arrow, the common voltage is changed from the second common voltage Vcom2 to the first common voltage Vcom1), the voltage of the pixel electrode VS of a pixel is driven. As indicated in FIGS. 1 and 2, the corresponding voltage ranges in the vicinities of the two common voltages Vcom1 and Vcom2 respectively correspond to two portions of the range of the data code. For example, when the grey value for the pixel ranges from 0 to 2^{N}−1, the range can be divided into two portions, namely, 0 to 2^{N-1}−1 and 2^{N-1} to 2^{N}−1. In the description below, the value of N is exemplified by 6.

The step of driving the voltage VS of the pixel electrode includes two sub-steps: (a) Within a time interval (e.g., the time interval T₁), the voltage of a pixel electrode of a pixel is pre-charged to one of a first voltage (e.g., V1) and a second voltage (e.g., V2) selectively, according to the value of a data code for the pixel and the polarity signal, so that the voltage of the pixel electrode, after having been pre-charged, becomes even closer to a corresponding target voltage of the data code. (b) Within another time interval (e.g., time interval T2), the pixel electrode, whose voltage has been precharged, is enabled to receive the target voltage so as to generate a desired voltage difference between the common electrode and the pixel electrode of the pixel.

The sub-step (a) of the second embodiment is implemented as follows: Whether the value of a data code for the pixel indicates that the corresponding target voltage of the data code falls within a corresponding voltage range in the vicinity of one of the two common voltages Vcom1 and Vcom2 is determined. The pixel electrode at the voltage VS is then pre-charged according to which voltage range the target voltage falls within, so that the voltage of the pixel electrode, after having been pre-charged, becomes even closer to a corresponding target voltage of the data code.

As indicated in FIG. 1, the corresponding voltage range in the vicinity of the first common voltage Vcom1 corresponds to a range of electric potential (denoted in dotted lines) indicated by the data codes of 0-31, tending downwards while the corresponding voltage range in the vicinity of the second common voltage Vcom2 corresponds to a range of electric potential (denoted in solid lines) indicated by the data codes of 32-63, tending upwards. Thus, there are two cases for the pre-charging of the pixel electrode.

Case 1: if the data code indicates that its corresponding target voltage falls within the corresponding voltage range in the vicinity of the first common voltage Vcom1, then, within the time interval T₁, the voltage of the pixel electrode of the pixel is pre-charged to the first voltage V1, so that the voltage of the pixel electrode, as indicated by the downward curve 130 during time interval T₁, becomes closer to the corresponding target voltage of the data code (e.g., 10) than the voltage of the pixel electrode before being pre-charged (e.g., the voltage during time interval T₀).

Case 2: if the data code indicates that its corresponding target voltage falls within the corresponding voltage range in the vicinity of the second common voltage Vcom2, within the time interval T₁, the voltage of the pixel electrode of the pixel is pre-charged to the second voltage V2, so that the voltage of the pixel electrode, as indicated by the upward curve 120 during time interval T₁, becomes closer to the corresponding target voltage of the data code (e.g., 60) than the voltage of the pixel electrode before being pre-charged.

With respect to the above two cases, the second embodiment may further include a step of driving a common electrode. The driving step includes: pre-charging the voltage of the common electrode of the pixel to the second voltage V2 within the time interval T₁, and enabling the pre-charged common electrode to receive the second common voltage Vcom2 within the time interval T₂.

As indicated in FIG. 2, the corresponding voltage range in the vicinity of the first common voltage Vcom1 corresponds to a range of electric potential denoted by the data codes of 32-63, tending downwards while the corresponding voltage range in the vicinity of the second common voltage Vcom2 corresponds to a range of electric potential denoted by the data codes of 0-31, tending upwards. Thus, there are also two cases for the pre-charging of the pixel electrode.

Case 3: if the data code indicates that its corresponding target voltage falls within the corresponding voltage range in the vicinity of the second common voltage Vcom2, then, within the time interval T₁, the voltage of the pixel electrode of the pixel is pre-charged to the second voltage V2, so that the voltage of the pixel electrode, as indicated by the upward curve 220 during time interval T₁, becomes closer to the corresponding target voltage of the data code (e.g., 0) than the voltage of the pixel electrode before being pre-charged.

Case 4: if the data code indicates that its corresponding target voltage falls within the corresponding voltage range in the vicinity of the first common voltage Vcom1, then, within the time interval T₁, the voltage of the pixel electrode of the pixel is pre-charged to the first voltage V1, so that the voltage of the pixel electrode, as indicated by the downward curve 230 during time interval T₁, becomes closer to the corresponding target voltage of the data code (e.g., 63) than the voltage of the pixel electrode before being pre-charged.

With respect to the above two cases, the second embodiment may further includes a step of driving a common electrode. The driving step includes: pre-charging the voltage of the common electrode of the pixel to the first voltage V1 within the time interval T₁, and enabling the pre-charged common electrode to receive the first common voltage Vcom1 within the time interval T₂.

The various examples of the second embodiment can achieve power saving and reduction in transition time. The data electrode and the common electrode still can be appropriately pre-charged to different levels even if the data electrode and the common electrode of a pixel have opposite changes in voltage. Thus, the problems of extra power consumption and longer transition time, which occur to the conventional driving method in which unnecessary voltage transition may occur in some cases, will be avoided.

### Third Embodiment

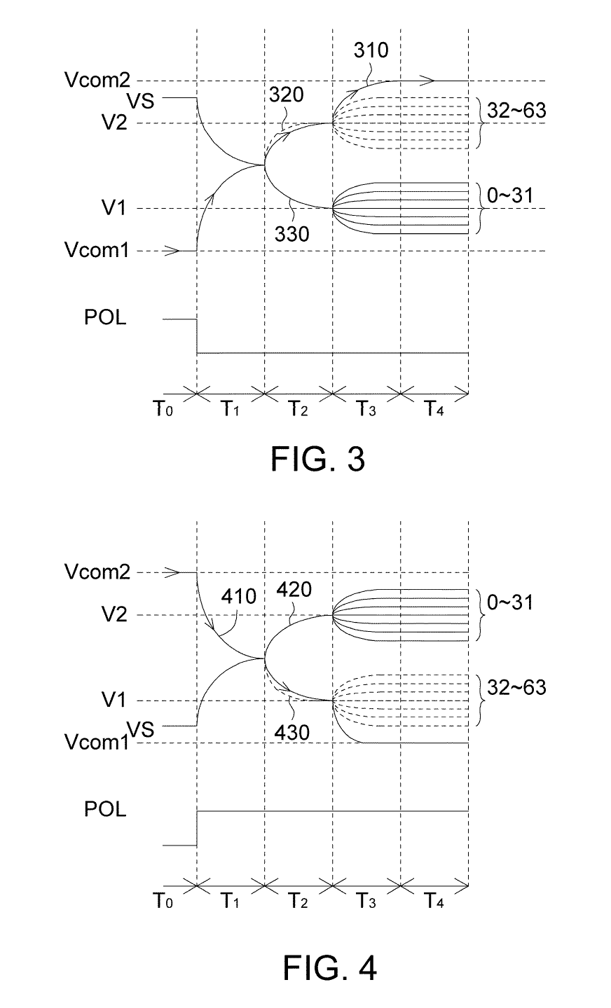

Referring to FIGS. 3 and 4, a schematic diagram of a driving method according to the third embodiment of the invention is respectively shown. The driving method of the third embodiment can be based on any of the above embodiments. Besides, the step of driving the voltage of a corresponding pixel electrode of a pixel further includes: within a time interval (e.g., the time interval T₁ of FIG. 3 or 4), connecting the common electrode and the pixel electrode of a pixel, or making the two electrodes short-circuited, so that the voltages of the two electrodes achieve a balance voltage. Afterwards, the step of making the voltage of the pixel electrode even closer to the corresponding target voltage of the data code is performed. In this manner, better performance in power saving and reduction in transition time can be achieved since the connecting method leads to charge redistribution by way of charge sharing.

The step of making the voltage of the pixel electrode even closer to the corresponding target voltage of the data code, for example, can be derived from the step of driving the voltage VS of the pixel electrode within the time interval T₁ and T₂ of FIG. 1 or 2 as described in the first or the second embodiment, and will not repeated for the sake of brevity.

When the pixel electrode and the common electrode have similar trends in the change of voltage, the pre-charging method can be replaced with a coupling method, so that the voltage of the pixel electrode becomes closer to the corresponding target voltage of the data code and power saving can be achieved.

As indicated in FIG. 3, if the polarity signal POL indicates that the common voltage is changed from positive polarity to negative polarity, the change in the common voltage Vcom is indicated by an upward curve 310 with an arrow. If the data code (e.g., 63) indicates that its corresponding target voltage falls within the corresponding voltage range in the vicinity of the second common voltage Vcom2, within the time interval T₂, it is to enable the pixel electrode of the pixel to enter a high-impedance state, so that the voltage of the pixel electrode substantially changes along with the voltage of the common electrode. On the other hand, within the time interval T₂, the voltage of the pixel common electrode is pre-charged to the second voltage V2. As indicated by the dotted line 320 of FIG. 3 within the time interval T₂, the voltage of the pixel electrode gradually boosts to the second voltage V2 through the parasitic capacitance of the common electrode and the data line. Next, within the time interval T₃, it is to enable the pre-charged common electrode to receive the second common voltage Vcom2, and enable the pixel electrode to receive the target voltage, so that a desired voltage difference is generated between the common electrode and the pixel electrode of a pixel. Besides, the pixel electrode of the pixel entering the high-impedance state can be realized, for example, by enabling the pixel electrode of the pixel to be floating substantially within the time interval T₂.

As indicated in FIG. 4, if the polarity signal POL indicates that the common voltage is changed from negative polarity to positive polarity, the change in the common voltage Vcom is indicated by a downward curve 410 with an arrow. If the data code (e.g., 63) indicates that its corresponding target voltage falls within the corresponding voltage range in the vicinity of the first common voltage Vcom1, within the time interval T₂, it is to enable the pixel electrode of the pixel to enter the high-impedance state, so that the voltage of the pixel electrode substantially changes along with the voltage of the common electrode. On the other hand, within the time interval T₂, the voltage of the pixel common electrode is pre-charged to the first voltage V1. As indicated by the dotted lines 430 FIG. 4 within the time interval T₂, the voltage of the pixel electrode gradually decreases to the first voltage V1 due to the parasitic capacitance of the common electrode and the data line. Other principles and manners that are similar to the cases illustrated in FIG. 3 can be implemented in the same manner, and are not repeated here.

Also, in other examples, the range within which the target voltage of the pixel electrode may fall can be divided into more than two sub-ranges. In this manner, the sub-range within which the target voltage falls can be determined according to the data code and the polarity signal, and the above sub-ranges are associated with a plurality of predetermined voltages.

That an embodiment of the invention performs efficiently in comparison to the conventional driving method in terms of voltage transition is exemplified by the case of the third embodiment in which the pixel electrode and the common electrode have different trends in the change of voltage.

Referring to FIG. 3, if the data code is one of 0˜31, within the time interval T₂, the pixel electrode of the pixel is pre-charged to the first voltage V1, as indicated in the curve 330, and the common electrode is pre-charged to the second voltage V2. Within the time interval T₃, the pre-charged the pixel electrode receives the target voltage (e.g., the data code is 0) so as to achieve a voltage difference (denoted by ΔV1). To simplify the estimation of the average power consumption Pᵢ, let the transition of the common voltage occur at the middle of a scan period and the middle of the next scan period, C_{load} denote the parasitic capacitance of the common electrode and the data line, the equivalent loading of a pixel be dominated by C_{load}, F denote the scan ratio, V_{w} denote the voltage difference of the parasitic capacitance before and after voltage transition, and the voltage V1 be 0V. Thus, in a scan period, the average current of a pixel is about C_{load}×V_{w}×F. In the above examples, the average power consumption PI_{T2} within the time interval T₂ is about ½×V2×C_{load}×V2×F, and the average power consumption PI_{T3} within the time interval T₃ is about ½×2V2×C_{load}×(|V2−ΔV1|)×F.

Also, the method used in the above examples may turn out to consume more power. Let FIG. 3 be taken for example. Suppose that the trend in the change of the voltage of the pixel electrode is opposite to that of the common electrode. According to the conventional method (e.g., the method disclosed in U.S. Pat. No. 7,362,293), the common electrode and the corresponding pixel electrode are coupled within a time interval (e.g., the time interval T₂) to receive a voltage of the same level (e.g., the voltage V2), and the average power consumption PP_{T2} during the time interval is 0. However, in the next time interval (e.g., the time interval T₃), the average power consumption PP_{T3} is: ½×2V2×C_{load}×(ΔV1)×F. The comparison between (PI_{T2}+PI_{T3}) and (PP_{T2}+PP_{T3}) shows that, under the above assumptions, if ΔV1>¾×VCI, then (PI_{T2}+PI_{T3})<(PP_{T2}+PP_{T3}).

Referring to FIG. 4, if the data code is 0˜31, pre-charging is first performed as indicated in the curve 420 within the time interval T₂, according to the third embodiment of the invention. Within the time interval T₃, a desired voltage difference (denoted by ΔV2) is generated between the data line and the common electrode. The average power consumption (PI_{T2}+PI_{T3}) between the time intervals T₂ and T₃ is about: ½×V2×C_{load}×VCI×F+½×3V2×C_{load}×(|VCI−ΔV2|)×F. According to the conventional method, the average power consumption (PP_{T2}+PP_{T3}) between the time interval T₂ and T₃ is about: ½×3VCI×C_{load}×(ΔV2)×F. The comparison between (PI_{T2}+PI_{T3}) and (PP_{T2}+PP_{T3}) shows that, under the above assumptions, if ΔV1>⅔×VCI, then (PI_{T2}+PI_{T3})<(PP_{T2}+PP_{T3}).

The above conditions and comparison results show that the above embodiments of the invention perform voltage transition efficiently. It is noted that the above formula (PP_{T2}+PP_{T3}) is not based on the results disclosed in the conventional art, but is a hypothetical example based on the conventional art and FIGS. 3 and 4 for the sake of illustration.

### Fourth Embodiment

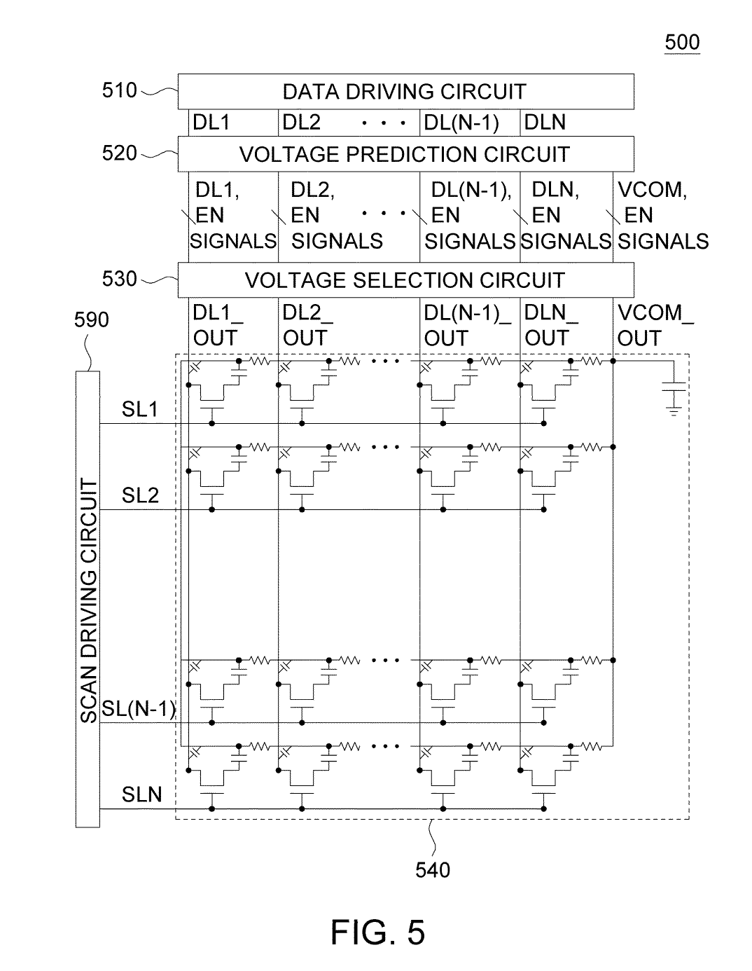

FIG. 5 shows a driving circuit for driving a pixel array 540 of a display panel 500 according to the fourth embodiment of the invention. The driving circuit includes a data driving circuit 510, a voltage prediction circuit 520, and a voltage selection circuit 530. Each of the above driving methods and embodiments can be implemented with the driving circuit.

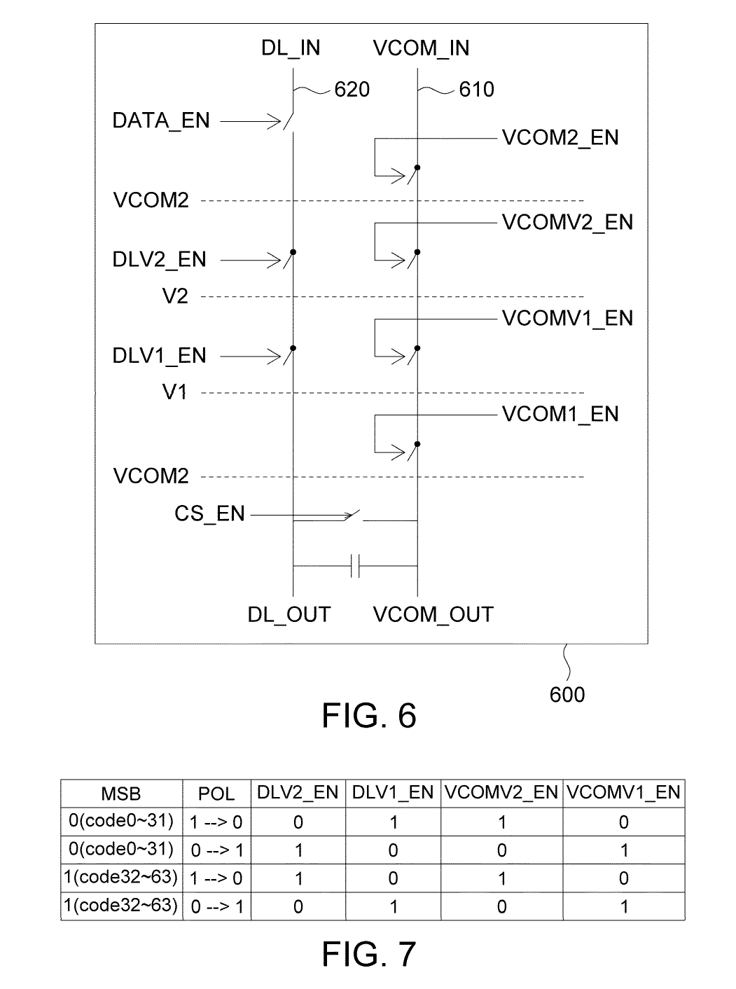

The data driving circuit 510 is for, according to a plurality of data codes and at least one of the polarity signal, driving a plurality of data lines (e.g., data lines DL1, DL2 to DLN) corresponding to the pixel array 540. The data driving circuit 510 such as includes a shift register, a data register, a digit analog convertor and a buffer amplifier (not illustrated) so as to generate a corresponding target voltage of the data line. With respect to each of the data codes, the voltage prediction circuit 520, according to the data code and its corresponding polarity signal, generates a plurality of data line control signals (denoted by EN signals in FIG. 5) corresponding to the data code and a plurality of common electrode control signals (denoted by EN signals in FIG. 5) corresponding to the polarity signal. The voltage selection circuit 530 is for, according to a plurality of common electrode control signals, changing a voltage of a common electrode (e.g., the common electrode 610 of FIG. 6) from one of a first common voltage (e.g., Vcom1) and a second common voltage (e.g., Vcom2) to the other thereof. Within a time interval (e.g., the time interval T₁ of FIG. 1 or FIG. 2 or the time interval T₂ of FIG. 3 or FIG. 4) during the transition in the voltage of the common electrode 610, the voltage selection circuit 530 enables the voltage of each of the data lines (e.g., the data line 620) to change to one of a first voltage (e.g., V1) and a second voltage (e.g., V2), according to a number of data line control signals of the corresponding data code of the data line (e.g., the data line 620 of FIG. 6), so that the voltage of the data line becomes closer to a corresponding target voltage of the corresponding data code. After the time interval, the voltage selection circuit 530 enables the data line whose voltage has been changed 620 to receive the target voltage from the data driving circuit 510 so as to generate a desired voltage difference between the data line 620 and the common electrode 610 for driving a pixel in the pixel array 540.

FIG. 6 shows a circuit diagram of an embodiment of a voltage selection circuit 530. In FIG. 6, the voltage selection circuit 600 includes a plurality of switching devices for selectively controlling the voltages received by the data lines and at least one of common electrode according to common electrode control signals and the data line control signal. For the sake of illustration, the diagram illustrates casean instance that the voltages received by a common electrode 610 and a data line 620 is under control. Based on the instance of FIG. 6, other circuit structures can be developed according to the first to the third embodiments and the other examples so as to implement other embodiments for such as the pre-charging or the receipt of the corresponding target voltage of different data lines, the pre-charging or the voltage transition for the common electrode, or the connection or coupling between the data line and the common electrode.

For example, the voltage selection circuit 600, according to a plurality of data lines control signals of the corresponding data code of a data line 620, e.g., the data line enabling signal DATA_EN, and the first and the second voltage enabling signals DLV1_EN and DLV2_EN, selects one of the first voltage V1 and the second voltage V2 and provides the selected one to the data line 620, so that the voltage of the data line becomes closer to the corresponding target voltage of the data code. In another example, the voltage selection circuit 600 is for, according to the data line control signals corresponding to the data code, enabling the data line 620 of the data code to receive one of the target voltage DL_IN corresponding to the data code, the first voltage V1, and the second voltage V2 selectively, or to be floating substantially.

In order to implement the third embodiment, the voltage selection circuit 600, before changing the voltage of the data line to one of the first voltage V1 and the second voltage V2, is further for connecting the common electrode 610 and the data line 620, so that the voltages of the common electrode 610 and the pixel electrode 620 achieve a balance voltage. In another example, the voltage selection circuit 600 enables the data line to enter a high-impedance state, so that the voltage of the data line changes along with the voltage of the common electrode.

With respect to the common electrode 610, the voltage selection circuit 600 includes a plurality of switching devices for, according to the common electrode control signals corresponding to the common electrode 610, enabling the common electrode 610 to receive one of the first voltage V1, the second voltage V2, the first common voltage Vcom1, and the second common voltage Vcom2 selectively. The common electrode control signal includes a first and a second voltage enabling signal VCOMV1_EN and VCOMV2_EN, and a first and a second common voltage enabling signal VCOM1_EN and VCOM2_EN.

In FIG. 6, the common electrode control signals and the data line control signals are generated by the voltage prediction circuit 520, for each of the data code, according to the data code and its corresponding polarity signal, wherein the data code is provided by the data driving circuit 510. In an example, the voltage prediction circuit 520 is realized based on a logic circuit. The truth table of FIG. 7 illustrates the input/output relationship of the voltage prediction circuit 520 realized by a logic circuit or a digit circuit. The voltage prediction circuit can also be realized by a combinational or sequential logic circuit or a timing control logic circuit, with logic gates or digit circuit such as a timer, a latch or a selector. For example, for each of the data code, the voltage prediction circuit 520 generates data line control signals corresponding to the data code such as the first and second voltage enabling signals DLV1_EN and DLV2_EN, according to at least one most significant bit (most significant bit, MSB) of the data code and the change in the polarity signal (POL). In another example, the voltage prediction circuit 520 generates corresponding common electrode control signals such as the first and second voltage enabling signals VCOMV1_EN and VCOMV2_EN, according to the change in a polarity signal (POL).

The four rows in the truth table of FIG. 7 respectively correspond to case 1 of FIG. 1, case 3 of FIG. 2, case 2 of FIG. 1, and case 4 of FIG. 2, which illustrate the pre-charging of the pixel electrode and the common electrode within a time interval T₁ as disclosed in the second embodiment. The truth table is also adaptable to the pre-charging of the pixel electrode and the common electrode within a time interval T₂ as disclosed in FIGS. 3 and 4 of the third embodiment. The enabling signals enables the voltage selection circuit 600 of FIG. 6 to control the pre-charging of the common electrode 610 and the pixel electrode 620.

When implementing the charge sharing of the third embodiment (e.g., at the time interval T₁), in an example, the common electrode control signals further include a charge sharing enabling signal CS_EN, and the voltage selection circuit 600 further includes a switch device for selectively connecting the data line and the common electrode according to the charge sharing enabling signal CS_EN. For example, the voltage prediction circuit 520 can set the charge sharing enabling signal CS_EN to be enabled (e.g., logic 1) and set the other enabling signals (e.g., logic 0) to be disabled, so that the data line 620 and common electrode 610 as indicated in FIG. 6 are short-connected.

In addition, in an implementation of the data line receiving a target voltage within the time intervals T₂ and T₃ of FIGS. 1 and 2, or the time intervals T₃ and T₄ of FIGS. 3 and 4, the voltage prediction circuit 520 can enable the data line enabling signal DATA_EN (such as logic 1) and disable other related enabling signals (such as logic 0). Likewise, in an implementation of the common electrode receiving one of a first common voltage (e.g., Vcom1) and a second common voltage (e.g., Vcom2), the voltage prediction circuit 520 can enable (e.g., logic 1) one of a first common voltage enabling signal VCOM1_EN and a second common voltage enabling signal VCOM2_EN and disable other related enabling signals (e.g., logic 0).

According to the above examples of generating the enabling signals, the voltage prediction circuit 520 can generate corresponding enabling signals according to the data code and the polarity signal at different time intervals, so as to implement the driving method disclosed in the above embodiments. In an example, the voltage prediction circuit 520 utilizes a clock signal generated by a timing controller of the display panel and refers to the change in the polarity signal so as to generate appropriate enabling signals at different time intervals. In another example, the voltage prediction circuit 520 refers to the change in the polarity signal and utilizes a duration of predetermined time interval, so as to determine the enabling signals that should be generated in response to different cases. Based on the above principles and embodiments, the voltage prediction circuit 520 and the driving method therefor can also be adaptable to other polarity inversion driving methods, such as frame inversion, column inversion, row inversion, and dot inversion, in which the enabling signals can be appropriately generated at different time points for changing the voltages of the data lines or the pixel electrodes to be close to the target voltages, hence achieving power saving and reduction in transition time.

Besides, the driving circuit according to the fourth embodiment is integrated on the display panel 500, but it is not limited thereto. In other examples, the scan driving circuit 590 can also be integrated on the display panel 500. In other examples, the driving circuit according to the fourth embodiment can be regarded as or integrated into a circuit module or an integrated circuit for driving a display panel.

The driving method and the driving circuit therefor disclosed in the above embodiments of the invention have many advantages exemplified below:

(1) Appropriate and effective voltage transition can be performed with respect to various cases such as the cases 1 and 3 of the second embodiment.

(2) The grey voltages in various cases of voltage transition can achieve power saving and reduction in transition time. During the transition of different frames data (patterns), the data lines and the common electrodes are changed to be close to the target voltages in advance to avoid the occurrence of glitch in the voltage waveform due to the interference of coupling effect. Thus, voltage transition can be done smoothly and the transition time can be reduced.

(3) Power saving and reduction in transition time can be achieved by circuits with lower complexity. In an example, adding a logic determination unit and a selection element to an ordinary driving circuit can achieve this, without significantly increasing the circuit area or incurring extra power consumption.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving method for driving a pixel array of a display panel, the driving method comprising:
driving a voltage of a corresponding pixel electrode of a pixel when a voltage of a corresponding common electrode of the pixel in a pixel array is changing from one of a first common voltage and a second common voltage to the other thereof according to a polarity signal, wherein the driving step comprises:
(a) within a first time interval, selectively changing the voltage of the pixel electrode of the pixel to one of at least a first voltage and a second voltage according to a value of a data code for the pixel and the polarity signal, so that the voltage of the pixel electrode, after having been changed, becomes closer to a corresponding target voltage of the data code; and
(b) within a second time interval, enabling the pixel electrode, whose voltage has been changed, to receive the target voltage so as to generate a desired voltage difference between the common electrode and the pixel electrode of the pixel;
wherein the second common voltage is larger than the second voltage, the second voltage is larger than the first voltage, and the first voltage is larger than the first common voltage.

2. The driving method according to claim 1, wherein the step (a) comprises:
determining whether the value of the data code indicates that the corresponding target voltage of the data code falls between the first common voltage and the second common voltage and within a corresponding voltage range in the vicinity of one of the first common voltage and the second common voltage;
within the first time interval, selectively pre-charging the voltage of the pixel electrode of the pixel to one of the first voltage and the second voltage according to the determination result, so that the voltage of the pixel electrode, after having been pre-charged, becomes even closer to the corresponding target voltage of the data code.

3. The driving method according to claim 2, wherein in the step (a):
within the first time interval, pre-charging the voltage of the pixel electrode of the pixel to the first voltage if the value of the data code indicates that the corresponding target voltage of the data code falls within the corresponding voltage range in the vicinity of the first common voltage, so that the voltage of the pixel electrode, after having been pre-charged, becomes closer to the corresponding target voltage of the data code.

4. The driving method according to claim 2, wherein in the step (a):
pre-charging the voltage of the pixel electrode of the pixel to the second voltage if the value of the data code indicates that the corresponding target voltage of the data code is within the corresponding voltage range in the vicinity of the second common voltage, so that the voltage of the pixel electrode, after having been pre-charged, becomes closer to the corresponding target voltage of the data code.

5. The driving method according to claim 2, wherein in the step (a), the data code includes an N-bit value, and whether the value of the data code indicates that the corresponding target voltage of the data code is within the corresponding voltage range in the vicinity of one of the first common voltage and the second common voltage is determined according to at least one most significant bit (MSB) of the data code.

6. The driving method according to claim 1, wherein before the step (a), the driving method further comprises:
electrically coupling the common electrode and the pixel electrode of the pixel, so that the voltages of the common electrode and the pixel electrode achieve a balance voltage.

7. The driving method according to claim 6, wherein the step (a) comprises:
determining whether the value of the data code indicates that the corresponding target voltage of the data code falls between the first common voltage and the second common voltage and within a corresponding voltage range in the vicinity of one of the first common voltage the second common voltage;
within the first time interval, selectively changing the balance voltage of the pixel electrode of the pixel to one of the first voltage and the second voltage by either of pre-charging and coupling selectively according to the determination result, so that the voltage of the pixel electrode, after having been changed, becomes closer to the corresponding target voltage of the data code.

8. The driving method according to claim 7, wherein in the step (a), when coupling method is adopted, the pixel electrode of the pixel substantially is floating within the first time interval so as to enter a high-impedance state.

9. The driving method according to claim 7, wherein in the step (a), if the value of the data code indicates that the corresponding target voltage of the data code falls within the corresponding voltage range in the vicinity of the other of the first common voltage and the second common voltage, then coupling method is adopted, and within the first time interval, the pixel electrode of the pixel enters a high-impedance state, so that the voltage of the pixel electrode changes along with the voltage of the common electrode.

10. A driving circuit for driving a pixel array of a display panel, wherein the driving circuit comprises:
a data driving circuit for driving a plurality of data lines corresponding to the pixel array according to a plurality of data codes and at least one polarity signal;
a voltage prediction circuit, with respect to each of the data codes, for generating a plurality of data line control signals corresponding to the data code and a plurality of common electrode control signals corresponding to the polarity signal, according to the data code and the polarity signal;
a voltage selection circuit, according to the common electrode control signals, for changing a voltage of a common electrode from one of a first common voltage and a second common voltage to the other thereof,
wherein within a time interval during a transition of the voltage of the common electrode, the voltage selection circuit is for enabling a voltage of each of the data lines to change to one of at least a first voltage and a second voltage, according to the data line control signals of the corresponding data code of the data line, so that the voltage of the data line becomes closer to a corresponding target voltage of the data code; and after the time interval, the voltage selection circuit is for enabling the data line, whose voltage has been changed, to receive the target voltage from the data driving circuit, so as to generate a desired voltage difference between the data line and the common electrode for driving a pixel in the pixel array;
wherein the second common voltage is larger than the second voltage, the second voltage is larger than the first voltage, and the first voltage is larger than the first common voltage.

11. The driving circuit according to claim 10, wherein the voltage selection circuit selects and provides one of the first voltage and the second voltage to the data line, according to the data line control signals of the corresponding data code of the data line, so that the voltage of the data line becomes closer to the corresponding target voltage of the data code.

12. The driving circuit according to claim 10, wherein before changing the voltage of the data line to one of the first voltage and the second voltage, the voltage selection circuit is further for coupling the common electrode and the data line so that the voltages of the common electrode and the pixel electrode achieve a balance voltage.

13. The driving circuit according to claim 12, wherein the voltage selection circuit selects and provides one of the first voltage and the second voltage to the data line, according to the data line control signals of the corresponding data code of the data line, so that the voltage of the data line becomes closer to the corresponding target voltage of the data code.

14. The driving circuit according to claim 12, wherein the voltage selection circuit, within the time interval, enables the data line to enter a high-impedance state if the data code indicates that the corresponding target voltage of the data code falls within a corresponding voltage range in the vicinity of the first common voltage and the polarity signal indicates that the voltage of the common electrode of the pixel is changed from the second common voltage to the first common voltage, so that the voltage of the data line changes along with the voltage of the common electrode.

15. The driving circuit according to claim 12, wherein the voltage selection circuit, within the time interval, enables the data line to enter a high-impedance state if the value of the data code indicates that the corresponding target voltage of the data code falls within a corresponding voltage range in the vicinity of the second common voltage and the polarity signal indicates that the voltage of the common electrode of the pixel is changed from the first common voltage to the second common voltage, so that the voltage of the data line changes along with the voltage of the common electrode.

16. The driving circuit according to claim 10, wherein the voltage selection circuit comprises a plurality of switching devices for selectively controlling the voltages received by the data lines and the common electrode according to the common electrode control signals and the data line control signals.

17. The driving circuit according to claim 10, wherein for each of the data codes, the data line control signals corresponding to the data code comprise a data line enabling signal, a first voltage enabling signal, and a second voltage enabling signal;
wherein the voltage selection circuit comprises a plurality of switching devices for, according to the data line control signals corresponding to the data code, enabling the corresponding data line of the data code to receive one of the target voltage corresponding to the data code, the first voltage, and the second voltage selectively, or to be floating substantially.

18. The driving circuit according to claim 10, wherein the common electrode control signals comprises a first voltage enabling signal, a second voltage enabling signal, a first common voltage enabling signal and a second common voltage enabling signal;
wherein the voltage selection circuit comprises a plurality of switching devices for, according to the common electrode control signals corresponding to the common electrode, enabling the common electrode to receive one of the first voltage, the second voltage, the first common voltage, and the second common voltage selectively.

19. The driving circuit according to claim 10, wherein for each of the data codes, the voltage prediction circuit generates the data line control signals corresponding to the data code according to at least one most significant bit (MSB) of the data code and the change in the polarity signal.
